(19) United States
(12) Patent Application Publication
(10) Pub. No.: US 2025/0007716 A1
(43) Pub. Date: Jan. 2, 2025

(54) SYSTEMS AND METHODS FOR PREDICTIVE GENERATION OF DATA TOKENS AND VISUAL PRESENTATION BASED ON DEVICE GEOLOCATION

(71) Applicant: BANK OF AMERICA CORPORATION, Charlotte, NC (US)

(72) Inventors: Durgesh Singh Yadav, Gautam Buddha Nagar (IN); Shanthini Devi Annamalai, Padur (IN)

(73) Assignee: BANK OF AMERICA CORPORATION, Charlotte, NC (US)

(21) Appl. No.: 18/216,683

(22) Filed: Jun. 30, 2023

(51) Int. Cl. H04L 9/32; H04W 12/63

(52) U.S. Cl. CPC H04L 9/3213; H04W 12/63

(57) ABSTRACT

This invention relates to predictive generation of data tokens and visual presentation based on device geolocation. It generates a user interface and transmits instructions to a user device for initiating actions due to proximity. Using GPS data from the user device, it determines proximity to a second device. The user device then receives instructions to display a transaction option with the second device. Upon receiving user instructions, the resource transaction is processed without needing more identifiers for the second device or its associated resource account.

### TECHNOLOGICAL FIELD

Example embodiments of the present disclosure relate to predictive generation of data tokens and visual presentation based on device geolocation.

### BACKGROUND

Users of peer-to-peer networks may wish to accurately and efficiently determine a potential recipient account to send a transmission. Applicant has identified a number of deficiencies and problems associated with predictive generation of data tokens. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for predictive generation of data tokens and visual presentation based on device geolocation. Users of peer-to-peer networks may wish to accurately and efficiently determine a potential recipient account to send a transmission. The invention provides a system for geolocation tracking of a sender user account's user device associated with submitting a transmission request, determining a location of a potential recipient account which has a matching or similar geolocation to the sender user. In this manner, the system may determine the sender user is likely in an entity associated with a particular recipient account, such that the sender user may only need to open a transaction application on their user device and the recipient account associated with the entity may automatically be pre-generated for selection to send the resource.

In some embodiments, the location of the recipient account may be identified by longitude and latitude coordinates, which may be used by the system to generate an encrypted token for the recipient account, whereby the recipient account may automatically be transmitted to without entering a mobile number, an email identifier, a quick response (QR) code, or the like. The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for predictive generation of data tokens and visual presentation based on device geolocation, in accordance with an embodiment of the disclosure; and

FIG. 2 illustrates a process flow for predictive generation of data tokens and visual presentation based on device geolocation, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The present disclosure provides a technical solution to a technical problem. As described herein, the technical problem includes the cumbersome and error-prone process of conducting resource transactions between devices, which often requires multiple steps and significant identifying information. The technical solution presented herein allows for streamlined and efficient resource transactions between devices based on proximity. In particular, this solution is an improvement over existing solutions to the resource transaction process, (i) with fewer steps to achieve the solution, thus reducing the amount of computing resources that are being used, (ii) providing a more accurate solution to the problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

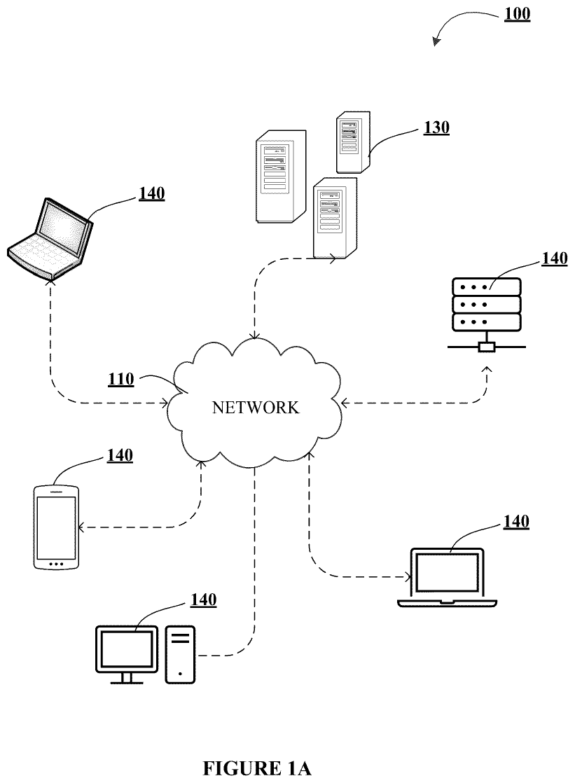

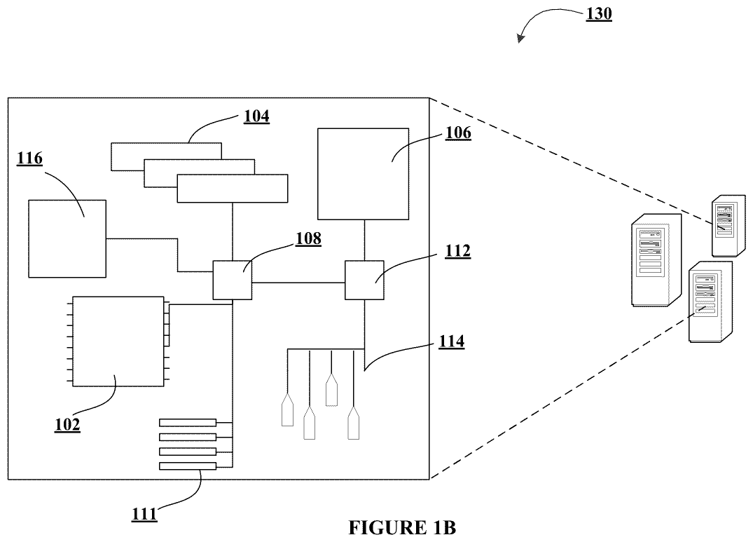

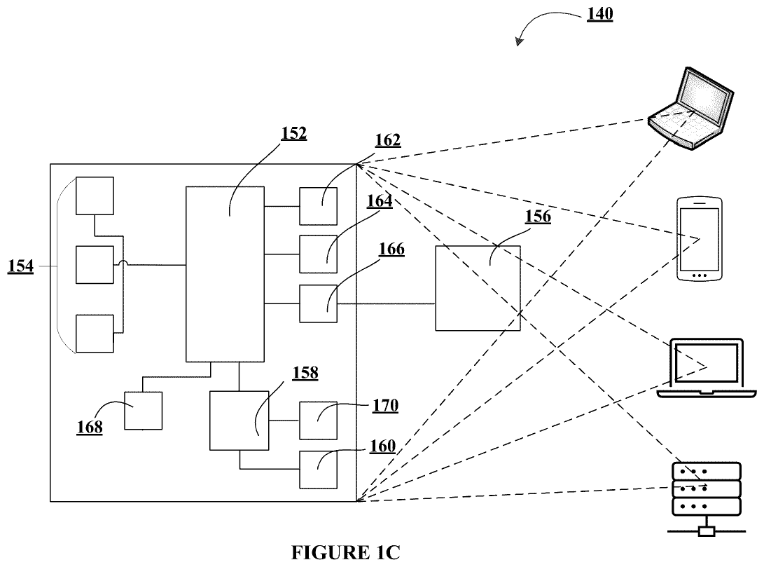

FIGS. 1A-1C illustrate technical components of an exemplary distributed computing environment 100 for predictive generation of data tokens and visual presentation based on device geolocation, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

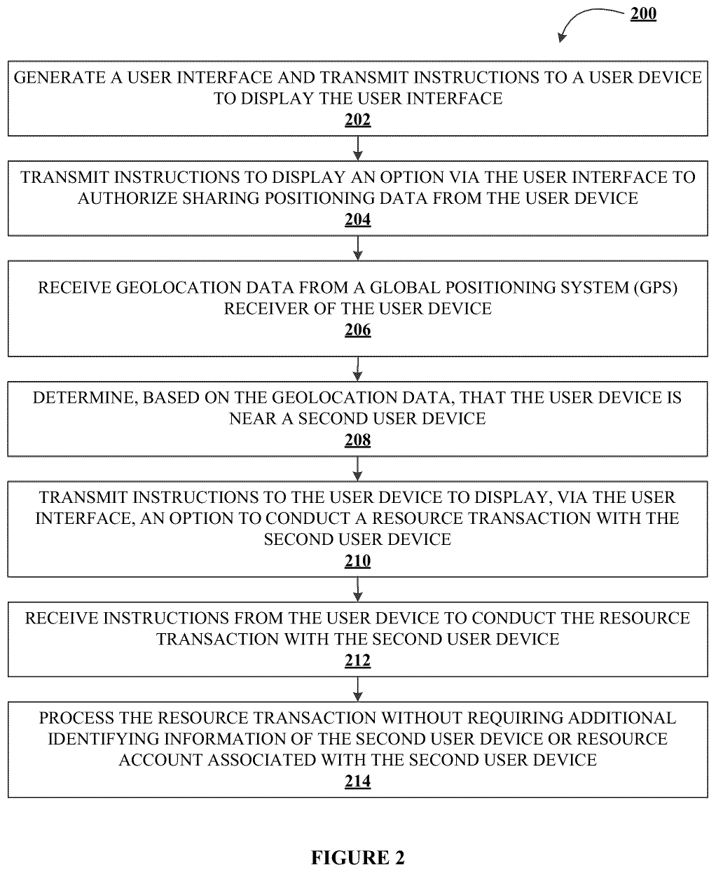

FIG. 2 illustrates a process flow for predictive generation of data tokens and visual presentation based on device geolocation, in accordance with an embodiment of the disclosure. As shown in FIG. 2 at block 202, the process begins whereby the system generates a user interface and transmits instructions to a user device to display the user interface. It is understood that programming a user interface for a user device or mobile device may be a complex process and involves several steps. One of ordinary skill in the art will also appreciate that that there are numerous methods, programming languages, and frameworks that can be used to accomplish this task. In some embodiments, the process begins by creating an intuitive and responsive design that caters to the user's needs. In the context of the present invention, this includes an application able to run on a mobile device which provides a user interface for payment processing, potentially using multiple different payment channels or payment accounts, as the user desires. In some embodiments, this step may involve using design tools like Sketch, Adobe XD, Figma, or the like, in order to finalize a design of the user interface. In ideal embodiments, the design adheres to the guidelines set by the mobile platforms (e.g., Android's Material Design and Apple's Human Interface Guidelines, or the like) for consistent user experience.

One of ordinary skill in the art will also appreciate that choosing a programming language for the user interface greatly depends on the target audience. For instance, creating a user interface for both iOS and Android necessitates a cross-platform framework like React Native (JavaScript), Flutter (Dart), or Xamarin (C #). Creating a user interface that is platform-specific may necessitate the use of programming languages such as Swift for iOS or Kotlin for Android. Once the design and technology stack are finalized, the user interface is built for either native or cross-platform deployment using the programming languages noted herein. Developing the user interface also includes writing code that handles user interactions, such as button clicks, text input, or the like. Once the application is developed, it is thoroughly tested on different devices with varying screen sizes and resolutions to ensure the interface works as expected.

When developers are confident in the user interface's functionality and performance, the user interface is deployed via transmitting instructions to the user device. For instance, in embodiments utilizing iOS, Xcode is used to build the project and then upload it to the App Store. For Android, Android Studio is used to create an APK or App Bundle, which is then published. The user may then download the application, install it on the user device, which executes the transmitted instructions to display the user interface of the application.

In terms of transmitting instructions to the user device to display the user interface, it is understood that this occurs at the application level. When a user opens the app, the mobile operating system (OS) loads compiled code into memory and starts executing it. The code then communicates with the OS to create the various user interface (UI) elements and respond to user interactions. The communication between the code and the OS is facilitated by the application programming interfaces (APIs) provided by the system. For example, Android SDK or iOS SDK. In some embodiments, the application does not send instructions to the device in real-time; rather, all the instructions are bundled in the app package itself, which gets installed on the user device.

As further shown in block 204, the process proceeds wherein the system may transmit instructions to display an option via the user interface to authorize sharing positioning data from the user device. It is understood that requesting access to location data via global positioning system (GPS) involves two main steps: requesting the necessary permissions from the user and then accessing the data if permission is granted. Depending on the operating system of the user device, this may include the general steps of requesting permission, checking and requesting permission at runtime, and accessing the location data. One of ordinary skill will appreciate that the exact manner in which location data is accessed and the level of accuracy available will depend on various factors, such as the specific capabilities of the device and the user's privacy settings. In some embodiments, additional location technologies may be utilized by the invention via the user device in a similar manner as GPS to enhance positioning accuracy, especially in areas where GPS signals may be weak or obstructed. These technologies include Assisted GPS (A-GPS), which uses cellular network data to assist in acquiring GPS satellite signals faster, and other positioning systems such as GLONASS (Global Navigation Satellite System) and Galileo, which are satellite-based navigation systems similar to GPS.

Moving further to block 206, the process continues wherein the system receives geolocation data from a GPS receiver of the user device. In some embodiments, it is understood that the system may receive other geolocation data from the user device, such as GLONASS data, A-GPS data, or other data that may aid in the accurate location of the user device. For instance, in some embodiments, Wi-Fi signals can be utilized for locating a mobile device through a technique called Wi-Fi triangulation or Wi-Fi positioning. This method relies on the presence of Wi-Fi access points (routers) and their signal strength measurements to estimate the location of the mobile device. In this way, the system may request access to the Wi-Fi transceiver of the user device in order to analyze signal strength of surrounding networks. The system may utilize a database to store known locations of access points along with their signal strength information. When a user device detects and measures the signal strength of multiple nearby Wi-Fi access points, it can compare those measurements with the information in the Wi-Fi database. By matching the signal strength data with the known locations of the access points, the device can estimate its own location or the system may estimate the location of the device.

As shown in block 208, as the system gathers location data from the user device, the system may determine, based on the geolocation data of the user device, that the device is within a predetermined distance of a second user device. Determining that two user devices are within a predetermined distance of each other based on collected geolocation data can be achieved using proximity-based algorithms. Both user devices need to collect their geolocation data using GPS, Wi-Fi, cellular network signals, or a combination of these technologies. The devices periodically update their respective locations. In some embodiments, the devices communicate with each other to exchange their geolocation data. This can be done through a direct connection, a network connection, or a centralized server acting as an intermediary, such as the system described herein. Once the devices have exchanged their geolocation data, they calculate the distance between their respective positions using mathematical algorithms. Various distance calculation methods can be used, such as the Haversine formula for spherical surfaces or the Euclidean distance formula for flat surfaces. The calculated distance between the two devices is then compared to the predetermined distance threshold that defines proximity. If the calculated distance is equal to or less than the predetermined threshold, it indicates that the devices are within the desired proximity of each other. Based on the outcome of the distance comparison, the system can determine whether the devices are within the predetermined distance of each other. This information can be used to trigger specific actions, notifications, or interactions between the devices or the associated applications. One of ordinary skill in the art will appreciate that the accuracy of the proximity determination depends on the precision of the geolocation data collected by the devices and the chosen distance calculation method. GPS generally provides higher accuracy than other positioning technologies, but it may be affected by factors such as signal obstruction or multipath interference in certain environments.

Once a proximity determination has been made, the system may transmit instructions to the user device to display, via the user interface, an option to conduct a resource transaction with the second user device, or an account associated with the second user device, as shown in block 210. In response, the system may receive instructions from the user device to conduct the resource transaction with the second user device or account associated with the second user device, as shown in block 212. Based on the information included in the instructions, the system may process the resource transaction without requiring additional identifying information of the second user device or resource account associated with the second user device, as shown in block 214. In some embodiments, the instructions received from the user device may include a resource amount, an account from which to withdraw funds, a chosen payment channel, or the like. In some embodiments, the option to conduct the resource transaction with the second user device may include identifying information of the account associated with the second user device, such as a known owner of the second user device, a known business associated with the second user device, or an identifying geographic characteristic of a merchant, logo, or the like in order that a user can quickly identify that the correct user device has been selected by the system in the option.

In some embodiments, this may include use of geolocation tracking of a sender user and their associated user device at a point of a resource transmission request, comparing the sender user's geolocation to at least one potential recipient user's geolocation data to automatically generate the recipient resource account as an option for the sender of the resource transmission. As previously noted, in certain embodiments, the system incorporates the functionality of geolocation tracking, which may be activated upon initiation of a resource transmission request by a sender user. The system is able to precisely track and record the geolocation of the sender user and the user device they are currently associated with. This technological advancement ensures a detailed and real-time tracking of the sender user's location, which is integral to the functionality of the system.

Following the resource transmission request, the system then commences a process of comparison. This step involves juxtaposing the recorded geolocation data of the sender user with the stored geolocation data of at least one potential recipient user. In order to facilitate this comparison, the system has access to, and can process, the geolocation data of various potential recipient users. This data may have been previously collected and stored in the system database, or it may be accessed in real-time depending on the configuration of the system. The output of this comparison process aids in automating the next step of the resource transmission process. Based on the comparative geolocation data, the system is capable of automatically generating a recipient resource account. This account corresponds to the most viable option for the sender of the resource transmission based on the comparison of geolocation data.

The utility of this feature lies in its automated nature, relieving the sender user from manually sifting through potential recipient options. Instead, the system smartly utilizes the geographical proximity data to suggest the most appropriate recipient resource account. This process enhances the efficiency, accuracy, and convenience of the resource transmission, thereby improving the overall user experience of the system. Furthermore, this feature could potentially be customized or combined with other system settings or user preferences, allowing for greater adaptability and flexibility. It may also accommodate a variety of other factors such as resource transmission history, transaction patterns, and user preferences, adding another layer of sophistication to the operation of this system. This underlines the comprehensive and innovative approach adopted in this invention to resource transmission requests, providing a seamless and intuitive user experience.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for predictive generation of data tokens and visual presentation based on device geolocation, the system comprising:
a processing device;
a non-transitory storage device containing instructions when executed by the processing device, causes the processing device to perform the steps of:
generate a user interface and transmit instructions to a user device to display the user interface;
transmit instructions to display an option, via the user interface, to authorize sharing positioning data from the user device;
receive geolocation data from a global positioning system (GPS) of the user device;
determine, based on the geolocation data, that the user device is near a second user device;
transmit instructions to the user device to display, via the user interface, an option to conduct a resource transaction with the second user device;
receive instructions from the user device to conduct the resource transaction with the second user device; and
process the resource transaction without requiring additional identifying information of the second user device or resource account associated with the second user device from the user device.

2. The system of claim 1, wherein transmitting instructions to the user device to display, via the user interface, the option to conduct the resource transaction with the second user device further comprises:
using geolocation tracking of a sender user and their associated user device at a point of a resource transmission request to compare the sender user's geolocation to at least one potential recipient user's geolocation data; and
automatically generating the recipient resource account as an option for the sender of the resource transmission.

3. The system of claim 1, wherein determining, based on the geolocation data, that the user device is near the second user device further comprises:
performing a Euclidean distance calculation utilizing the geolocation data and pre-stored geolocation data of the second user device to determine distance between the user device and the second user device;
comparing the distance to a predetermined distance threshold that defines proximity; and
generating an indication that the user device and second user device are within the proximity of each other via transmission of the option to conduct the resource transaction with the second user device.

4. The system of claim 1, further configured to utilize Global Navigation Satellite System (GLONASS) data in addition to the data from the GPS of the user device.

5. The system of claim 1, further configured to:
receive Wi-Fi data from the user device, wherein the Wi-Fi data comprises measurements of signal strength of Wi-Fi networks nearby the user device;
compare the Wi-Fi data with information in a pre-stored Wi-Fi database; and
match the signal strength of Wi-Fi networks nearby the user device with known locations of access points to estimate location of the user device.

6. The system of claim 1, wherein processing the resource transaction without requiring additional identifying information of the second user device or resource account associated with the second user device from the user device further comprises automatically locating an account identifier associated with the second user device and transmitting resources from an account associated with the user device to an account signified by the account identifier associated with the second user device.

7. The system of claim 1, further configured to transmit instructions to cause the user interface to display a resource value option, wherein the resource value option comprises an option to set an exact resource transaction value and resource type.

8. A computer program product for predictive generation of data tokens and visual presentation based on device geolocation, the computer program product comprising a non-transitory computer-readable medium comprising code causing an apparatus to:
generate a user interface and transmit instructions to a user device to display the user interface;
transmit instructions to display an option, via the user interface, to authorize sharing positioning data from the user device;
receive geolocation data from a global positioning system (GPS) of the user device;
determine, based on the geolocation data, that the user device is near a second user device;
transmit instructions to the user device to display, via the user interface, an option to conduct a resource transaction with the second user device;
receive instructions from the user device to conduct the resource transaction with the second user device; and
process the resource transaction without requiring additional identifying information of the second user device or resource account associated with the second user device from the user device.

9. The computer program product of claim 8, wherein transmitting instructions to the user device to display, via the user interface, the option to conduct the resource transaction with the second user device further comprises:
using geolocation tracking of a sender user and their associated user device at a point of a resource transmission request to compare the sender user's geolocation to at least one potential recipient user's geolocation data; and
automatically generating the recipient resource account as an option for the sender of the resource transmission.

10. The computer program product of claim 8, wherein determining, based on the geolocation data, that the user device is near the second user device further comprises the non-transitory computer-readable medium further comprising code causing an apparatus to:
performing a Euclidean distance calculation utilizing the geolocation data and pre-stored geolocation data of the second user device to determine distance between the user device and the second user device;
comparing the distance to a predetermined distance threshold that defines proximity; and
generating an indication that the user device and second user device are within the proximity of each other via transmission of the option to conduct the resource transaction with the second user device.

11. The computer program product of claim 8, wherein the non-transitory computer-readable medium comprising code further causes the apparatus to: utilize Global Navigation Satellite System (GLONASS) data in addition to the data from the GPS of the user device.

12. The computer program product of claim 8, wherein the non-transitory computer-readable medium comprising code causing an apparatus to:
receive Wi-Fi data from the user device, wherein the Wi-Fi data comprises measurements of signal strength of Wi-Fi networks nearby the user device;
compare the Wi-Fi data with information in a pre-stored Wi-Fi database; and
match the signal strength of Wi-Fi networks nearby the user device with known locations of access points to estimate location of the user device.

13. The computer program product of claim 8, wherein processing the resource transaction without requiring additional identifying information of the second user device or resource account associated with the second user device from the user device further comprises automatically locating an account identifier associated with the second user device and transmitting resources from an account associated with the user device to an account signified by the account identifier associated with the second user device.

14. The computer program product of claim 8, wherein the non-transitory computer-readable medium comprising code causing an apparatus to: transmit instructions to cause the user interface to display a resource value option, wherein the resource value option comprises an option to set an exact resource transaction value and resource type.

15. A method for predictive generation of data tokens and visual presentation based on device geolocation, the method comprising:
generating a user interface and transmit instructions to a user device to display the user interface;
transmitting instructions to display an option, via the user interface, to authorize sharing positioning data from the user device;
receiving geolocation data from a global positioning system (GPS) of the user device;
determining, based on the geolocation data, that the user device is near a second user device;
transmitting instructions to the user device to display, via the user interface, an option to conduct a resource transaction with the second user device;
receiving instructions from the user device to conduct the resource transaction with the second user device; and
processing the resource transaction without requiring additional identifying information of the second user device or resource account associated with the second user device from the user device.

16. The method of claim 15, wherein transmitting instructions to the user device to display, via the user interface, the option to conduct the resource transaction with the second user device further comprises:
using geolocation tracking of a sender user and their associated user device at a point of a resource transmission request to compare the sender user's geolocation to at least one potential recipient user's geolocation data; and
automatically generating the recipient resource account as an option for the sender of the resource transmission.

17. The method of claim 15, wherein the method further comprises:
performing a Euclidean distance calculation utilizing the geolocation data and pre-stored geolocation data of the second user device to determine distance between the user device and the second user device;
comparing the distance to a predetermined distance threshold that defines proximity; and
generating an indication that the user device and second user device are within the proximity of each other via transmission of the option to conduct the resource transaction with the second user device.

18. The method of claim 15, wherein the method further comprises: utilizing Global Navigation Satellite System (GLONASS) data in addition to the data from the GPS of the user device.

19. The method of claim 15, wherein the method further comprises:
receiving Wi-Fi data from the user device, wherein the Wi-Fi data comprises measurements of signal strength of Wi-Fi networks nearby the user device;
comparing the Wi-Fi data with information in a pre-stored Wi-Fi database; and
matching the signal strength of Wi-Fi networks nearby the user device with known locations of access points to estimate location of the user device.

20. The method of claim 15, wherein processing the resource transaction without requiring additional identifying information of the second user device or resource account associated with the second user device from the user device further comprises automatically locating an account identifier associated with the second user device and transmitting resources from an account associated with the user device to an account signified by the account identifier associated with the second user device.
